(19) United States
(12) Patent Application Publication
(10) Pub. No.: US 2003/0088721 A1
(43) Pub. Date: May 8, 2003

(54) Method and system for controlling flow of ordered, pipelined transactions between intercommunicating electronic devices

(76) Inventor: Debendra Das Sharma, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/011,857

(22) Filed: Nov. 5, 2001

(51) Int. Cl. G06F 13/00; G06F 13/36

(52) U.S. Cl. 710/112

(57) ABSTRACT

A method and system for flow control of ordered, pipelined transaction requests within a system of intercommunicating electronic devices. The method and system rely on information stored within a producing node, information stored within a consuming node, and information added to certain transaction requests as they are transmitted from the producing node to the consuming node. In the producing node, outstanding transaction requests are maintained within a source input queue, each transaction request associated with a retry bit. When a message is transmitted from the producing node to the consuming node, a special marker bit may be included to flag certain messages as special to the consuming node. The consuming node maintains a retry vector having a retry bit corresponding to each producing node.

### TECHNICAL FIELD

The present invention relates to electronic information exchange and, in particular, to a method, implementable in logic circuits, and system for controlling the flow or ordered, pipelined instructions between a first electronic device, or producing node, and a second electronic device, or consumer node, interconnected by an electronic information exchange medium and, optionally, by intervening forwarding nodes.

### BACKGROUND OF THE INVENTION

The present invention is concerned with flow control of ordered, pipelined transactions between a first electronic device, referred to as a “producing node,” that transmits the ordered, pipelined transactions, and a second electronic device, referred to as a “consuming node,” that receives the ordered, pipelined transactions, both the producing and consuming nodes operating within a system of intercommunicating electronic components. Electronic devices are referred to as “nodes” because, when a system of interconnected electronic devices is viewed abstractly as a graph, the electronic devices can be viewed as vertices or nodes interconnected by edges comprising communications media such as busses and signal lines. The present invention provides a relatively straightforward method for flow control that can be implemented in logic circuits within an electronic device such as a bus-bridge device or routing device within a computer system.

FIG. 1 illustrates an example computer-system environment in which ordered, pipelined transactions may require flow control to buffer disparities between the rates of transaction request production by producing nodes and transaction request consumption by transaction request consuming nodes. FIG. 1 shows a portion of a multi-processor computer system, including four processors 102-105, two north-bridge bus-interconnection components 106 and 107, an input/output (“I/O”) bridge 108, a number of south-bridge bus-interconnection components 110-115, and a multitude of I/O cards, peripheral devices, and other I/O devices 116-133. The I/O devices intercommunicate with the south-bridge devices via a number of I/O busses, such as peripheral component interconnect (“PCI”) busses 134-139. The processors 102-105 are linked to north-bridge devices 106-107 via processor busses 140 and 141. Various other busses and signal lines interconnect the north-bridge devices 106 and 107 with the I/O-bridge device 108, memory devices, and other electronic components within the computer system. In FIG. 1, circular input and output queues are associated with busses and signal lines within the north-bridge 106-107 and I/O-bridge 108 devices. Units of transferred information, such as communications protocol packets or messages, are received by a bridge device from a bus or signal line and queued to an input queue, dequeued from the input queue for processing by bridge-device control logic that may queue packets or messages to output queues for transmission over a bus or signal line to remote electronic devices. For example, north bridge 106 receives processor transaction requests from processors 102 and 103 via processor bus 140 and input queue 142. North bridge 106 sends replies to transaction requests to processors 102 and 103 via output queue 144 and processor bus 140. North bridge 106 receives packets or messages from the I/O bridge 108 via communications medium 145 and input queue 147 and transmits packets or messages to the I/O bridge 108 via communications medium 145 and output queue 146.

Each bridge device essentially multiplexes communications between a number of different electronic communications media. Bridge devices interconnect different physical communications media, coalescing incoming packet or message streams via input queues, and redistributing packets and messages to outgoing streams via output queues. Bridge devices serve analogous roles to switching stations in telephone networks, allowing packets or messages to be routed from source devices to destination devices through pathways comprising multiple communications media. For example, processor 102 may send an I/O transaction request to I/O device 118 via north bridge 106, I/O bridge 108, and south bridge 110. The transaction request is sent by processor 102 through processor bus 104 to north bridge 106, where the transaction request is queued by low level hardware and control logic to input queue 142. The north bridge control logic eventually dequeues the transaction request from input queue 142, determines, from the contents of the packet, to which I/O device the transaction request is being sent, and consults internal destination/output queue maps in order to select a suitable output queue, in this case output queue 146, to which to queue the transaction request for transmission to a next electronic device on the pathway to the destination I/O device 117. The transaction request is dequeued from the output queue 146 and transmitted via a communications medium, by low level hardware and control logic, to the I/O bridge 108, where the transaction request is queued to input queue 148. The I/O bridge control logic dequeues the transaction request from input queue 148, identifies the destination for which the transaction request is intended, and queues the transaction request to a suitable output queue, in this case output queue 150, for transmission to the next electronic device in the pathway to the destination I/O device, namely south bridge 110. When south bridge 110 receives the transaction request, the south bridge forwards the transaction request via PCI bus 134 to the intended destination I/O device 118.

The communications medium interconnecting any two devices in the pathway between a source device and a destination device employs a communications protocol for transmitting transaction requests and for returning responses. For example, when north bridge 106 transmits the transaction request to I/O bridge 108, I/O bridge 108 may respond to the transaction request received from north bridge 106 with an acceptance, or “ACK” reply, to indicate that the I/O bridge has received the transaction request and can accommodate the transaction request within internal buffers, or with a negative reply, called a “NAK,” to indicate that the I/O bridge cannot, for one of various reasons, accept the transaction request. The transmission request and ACK/NAK reply model is one simple type of protocol. Each different communications medium may employ a different protocol, and may encode and transmit electronic information by different electronic encoding and transmission means. Bridge devices serve as translating devices to interconnect communications media with different encoding schemes, transmission schemes, and communications protocols.

Unfortunately, the rates at which a producing node, such as a north bridge in FIG. 1, can produce outgoing packets may differ significantly from the rate at which a consuming node, such as the I/O bridge, can receive and process the packets. Disparities in the rates of production and consumption can lead to queue overflow and underflow conditions, bottlenecks, and other problems and inefficiencies within a system of interconnected communicating electronic devices. For example, processor 102 may send transaction requests to I/O devices attached to PCI bus 134 at a much higher rate than the transaction requests can be processed by the I/O devices. The transaction requests may backup on, and flood, output queue 150 within I/O bridge 108, in turn causing backup of input queue 148, output queue 146, and input queue 142.

In general, flow control mechanisms are employed to prevent deleterious effects of consumption rate and production rate disparities between communicating electronic devices. Many different types of flow control techniques may be employed. Generally, in hardware devices such as bridges, control logic is implemented in logic circuits and combinations of logic circuits and firmware routines, which constrains the selection of flow control techniques to those that can be relatively simply and straightforwardly implemented. By contrast, in higher-level, inter-computer communications protocols, such as the Internet protocol, complex flow control logic may be implemented in complex software programs, using a variety of higher-level logical constructs and data structures, such as time stamps, hierarchically organized protocol stacks, logical message sequencing, and efficient and high-capacity buffering techniques. In general, these techniques cannot be economically and efficiently implemented in the logic circuits and firmware routines available to designers of bus bridges and other lower-level electronic devices within computers.

FIGS. 2A-D illustrate a flow control problem particular to ordered transactions. FIGS. 2A-D employ a simple diagrammatic convention in which numerically labeled and ordered packets are transferred from a first source output queue 202 within a source node to a forwarding-node queue 204 within a forwarding node, from which the packets are transmitted to a destination input queue 206 within a destination node. FIG. 2A shows an initial snapshot, in time, of the transfer of a lengthy, ordered sequence of packets from source output queue 202 to destination input queue 206. Packets 1-13 have been successfully transferred to destination input queue 206, packets 14-17 are queued to forwarding-node queue 204 for forwarding to destination input queue 206, and packets 15-18 have been queued to source queue 202 for transmission to forwarding-node queue 204. As discussed above, other queues and control logic are involved in the transmission of packets between electronic devices, but need not be considered to demonstrate the flow-control problem. Note that, in FIGS. 2A-D, ACK replies are generally not shown being returned from the destination node to the forwarding node, and from the forwarding node to the source node.

In FIG. 2B, the destination node has consumed packet 1 from destination queue 206, and has received packets 14-17 from the forwarding-node queue and queued packets 14-17 to destination input queue 206. The forwarding node has received five additional packets 18-22 from the source output queue 202 and has queued packets 18-22 to the forwarding-node queue 204 for eventual forwarding to the destination queue 206. Packets 23-29 have been queued to the source output queue 206. Thus, in FIG. 2B, the first packet has been consumed by the destination entity, additional packets have been forwarded from the forwarding-node queue to the destination queue and from the source queue to the intermediate queue, and additional packets have been produced and queued to the source output queue 202.

In FIG. 2C, the destination has, for some reason, discontinued consuming packets. Because the destination queue is full, the destination node has been forced to transmit a NAK reply 210 corresponding to packet 18 back to the forwarding node, and the forwarding node has, in turn, transmitted a NAK reply 212 back to the source entity. However, packets 19-23 have already been queued to intermediate queue 204 and remain there.

In FIG. 2D, the destination node has resumed consuming packets. Having consumed packets 2-5, the destination node now has additional room on the destination queue for receiving packets forwarded from the forwarding-node queue 204. Hence, packet 19 has been received from the forwarding-node queue and queued to the destination queue 206. Packets continue to be forwarded from forwarding-node queue 204 to destination queue 206. The source node, upon receiving the NAK corresponding to packet 18, has requeued packet 18 to the head of the source output queue 202. Assuming that destination packet consumption continues at a rate sufficient to prevent further backup of destination queue 206, the destination node will consume, in order, packets 6-17 and then consume packet 19 following consumption of packet 17. Packet 18 will appear on the destination input queue only after packets 20-23 have been queued to the destination input queue. Thus, the simple NAK-based flow control technique illustrated in FIGS. 2A-D results in an out-of-order consumption of an ordered sequence of packets by the destination node.

In many cases, transaction requests may be consumed and executed out-of-order without deleteriously affecting an overall sequence of transaction requests. However, in other cases, out-of-order consumption and execution of transaction requests may result in a markedly different cumulative outcome than would have resulted from in-order consumption and execution of the transaction requests. FIGS. 3A-B illustrate an ordered, multi-transaction-request cumulative I/O transaction in which out-of-order execution of individual transaction requests produces a different result than in-order execution of individual transaction requests. In FIGS. 3A-B, a small region of data storage, provided by an I/O device or electronic memory and having 16 data cells, such as cell 302, is shown prior to, during, and after execution of a series of I/O transaction requests. In FIG. 3A, the initial contents of the data-storage region 300 is shown containing the data values “A” in cells 0-2, “B” in cell 3, “C” in cell 4, “D” in cells 5 and 6, “E” in cells 7 and 8, and “X” in cells 9-15. A first transaction request 304 is executed on this data-storage region. It is a WRITE request requesting that the value r be written to four cells beginning with cell 7. The data-storage region 306 is again shown, following execution of the first I/O transaction request, with cells 7-10 containing the data value “R.” A second I/O transaction request 308 is then executed, placing the data value “Z” into the four cells begging with cell 10, as shown in the representation of the data-storage region 310 following the second I/O transaction request 308. Finally, a third I/O transaction request 312 is carried out to write the data value “Y” into six cells beginning with cell 2, and the result is shown in the final representation of the data-storage region 314.

FIG. 3B shows the same initial data-storage region 300, but with a different order of I/O transaction execution. In FIG. 3B, the second transaction request 308 of FIG. 3A is executed first, followed by the third transaction request 312 of FIG. 3A, and then followed by the first transaction request 304 of FIG. 3A. Note that the final data contents of the data-storage region 316 in FIG. 3B differs from the final contents of the data-storage region 314 shown in FIG. 3A.

In general, the outcome of a cumulative I/O transaction comprising multiple outstanding WRITE transaction requests, or, in other words, pipelined WRITE transaction requests, is highly dependent on the order of execution of the pipelined WRITE requests. In sophisticated, software-implemented communications protocols, receiving nodes can employ sequence numbers, time stamps, and/or buffering mechanisms to resequence transaction requests received out-of-order. However, lower-level logic-circuit and firmware implementations within devices such as bus-bridge interconnects cannot economically employ these sophisticated resequencing methods. These lower-level devices lack sufficient memory capacity to buffer and re-order out-of-sequence packets, lack the logic capacity for complex resequencing operations, and are additionally constrained by lower-level packet formats and bus protocols employed in the communications media to which they interface. Flow control techniques, such as the flow-control technique illustrated in FIGS. 2A-D, may result in out-of-order consumption of transaction requests by a destination node, in turn resulting in an incorrect, or unexpected, cumulative result stored in a destination I/O device.

FIG. 4 is an abstract representation of the flow of packets from processors to I/O bus output queues in the system illustrated in FIG. 1. As shown in FIG. 4, packets or messages originating at the processors 401-404, partially coalesce at the north bridge devices 406-407, further coalesce into a single packets stream in the I/O bridge 408 before being distributed among six different output streams 410-415 directed to the south bridge devices that forward the packets on to PCI busses. The present invention concerns a flow control method based on NAK replies and retrying of rejected transaction requests. As illustrated in the example of FIGS. 3A-B, when NAK-based transaction requests retries are issued for ordered transactions, the final order of receipt and execution may differ from the order in which the transaction requests are produced.

Currently, in order to prevent out-of-order receipt and consumption of ordered transaction requests, several techniques are employed. One technique is to allow only a single outstanding transaction request within the system for each producing node. This technique is equivalent to having a single packet buffer for each processor in place of the input queue within a north bridge device. By allowing only a single outstanding transaction request, the system can guarantee that a rejected transaction request may be retried, received, and consumed prior to reception and consumption of any subsequent transaction requests from a particular source. This technique thus results in in-order reception and consumption of transaction requests emanating from a given processor. However, this technique guarantees in-order reception and consumption of transaction requests at a relatively high cost—namely, single-threading of transaction requests from a particular processor. With respect to FIG. 4, this technique is equivalent to throttling the packet stream produced by a particular processor at the first packet stream convergence point, namely north bridges 406 and 407. Consider, however, the example of a particular processor concurrently directing transaction requests to each of the final output streams 410-415, with consumption of transaction requests from only one of the six output streams 410-415 slow relative to the transaction request production rate of the processor. By throttling the transaction request stream at the north bridge, a great deal of potential parallel execution of transaction requests by the system is prevented, significantly decreasing the transacting bandwidth available to each processor as well as increasing the latency for cumulative I/O operations. Moreover, NAK replies must traverse several nodes within the system in order to have their desired effect. In the example shown in FIG. 4, when output stream 415 becomes blocked, a NAK request corresponding to a first rejected transaction request must be passed back through the I/O bridge 408 to the north bridge 407, and when output stream becomes unblocked, the transaction request must be reissued through the I/O bridge 408.

Another common technique currently employed to prevent out-of-order reception and consumption of ordered transaction requests is to simply disallow ordered, pipelined transaction requests, or, in other words, to not guarantee in-order reception and consumption of transaction requests by a consuming node transmitted from a producing node. While many cumulative I/O operations can be carried out in a series of smaller, unordered I/O operations, there are cases where disallowing ordered transaction requests contributes great complexity to implementation of higher-level tasks.

Thus, current techniques for preventing out-of-order reception and consumption of ordered transaction requests either greatly diminish the efficiency of a computer system or increase the complexity and cost of implementing higher-level tasks more easily implemented on top of an ordered transaction facility. For these reasons, designers of computer systems and other systems employing multiple, interconnected and intercommunicating electronic devices have recognized the need for a straightforward technique for flow control of ordered, pipelined transaction requests.

### SUMMARY OF THE INVENTION

One embodiment of the present invention provides a method and system for straightforward and easily implemented flow control of ordered, pipelined transaction requests within a system of intercommunicating electronic devices. This embodiment of the present invention relies on information stored within a producing node, information stored within a consuming node, and information added to certain transaction requests as they are transmitted from the producing node to the consuming node. In the producing node, outstanding transaction requests are maintained within a source input queue, each transaction request associated with a retry bit. When a message is transmitted from the producing node to the consuming node, a special marker bit may be included to flag certain messages as special to the consuming node. The consuming node maintains a retry vector having a retry bit corresponding to each producing node. When the producing node receives a NAK reply from the consuming node rejecting a transaction request, the producing node sets the retry bit for the transaction request in the source input queue, as well as the retry bits for other pending, subsequently received transaction requests directed to the consuming node. The producing node then proceeds to retransmit the transaction request and any additional pending, subsequently received transaction requests to the consuming node. When the producing node transmits the oldest transaction request pending for a particular consuming node, the producing node sets the special marker bit within the transaction request to flag the transaction request to the consuming node. When a consuming node receives a transaction request from the producing node, it first checks the retry vector to determine whether or not the retry vector bit corresponding to the producing node has been set. If so, then the consuming node responds with a NAK reply unless the special marker bit within the transaction request is set. If the special marker bit is set, and if the retransmitted transaction request can now be accommodated by the consuming node, the consuming node resets the bit within the retry vector corresponding to the producing node and replies with an ACK reply to the producing node. This technique guarantees that, once the consuming node rejects a transaction request within an ordered stream of transaction requests, the transaction request will be retransmitted by the producing node in the proper order.

### BRIEF DESCRIPTION OF THE DRAWINGS

FIG. 1 illustrates an example computer-system environment in which ordered, pipelined transactions may require flow control to buffer disparities between the rates of transaction request production by producing nodes and transaction request consumption by transaction request consuming nodes.

FIGS. 2A-D illustrate a flow control problem particular to ordered transactions.

FIGS. 3A-B illustrate an ordered, multi-transaction-request cumulative I/O transaction in which out-of-order execution of individual transaction requests produces a different result from in-order execution of individual transaction requests.

FIG. 4 is an abstract representation of the flow of packets from processors to I/O bus output queues in the system illustrated in FIG. 1.

FIG. 5 shows the data structures employed by a producing and a consuming node to which the flow control technique of the present invention is applied.

FIG. 6 is a flow control diagram of an inner control loop within the control logic of both the producing and consuming nodes.

FIG. 7 is a flow control diagram for the routine “trans_received” called by the inner control loop of a producing node.

FIG. 8 is a flow control diagram for the routine “trans_received” called from the inner control loop of a consuming node.

FIG. 9 is a flow control diagram for the routine “reply_received,” called by the inner control loop of a producing node upon queuing of a reply message to the destination input queue within the producing node.

FIGS. 10A-H illustrate operation of the flow control technique of the present invention as applied to the producing and consuming nodes illustrated in FIG. 5.

### DETAILED DESCRIPTION OF THE INVENTION

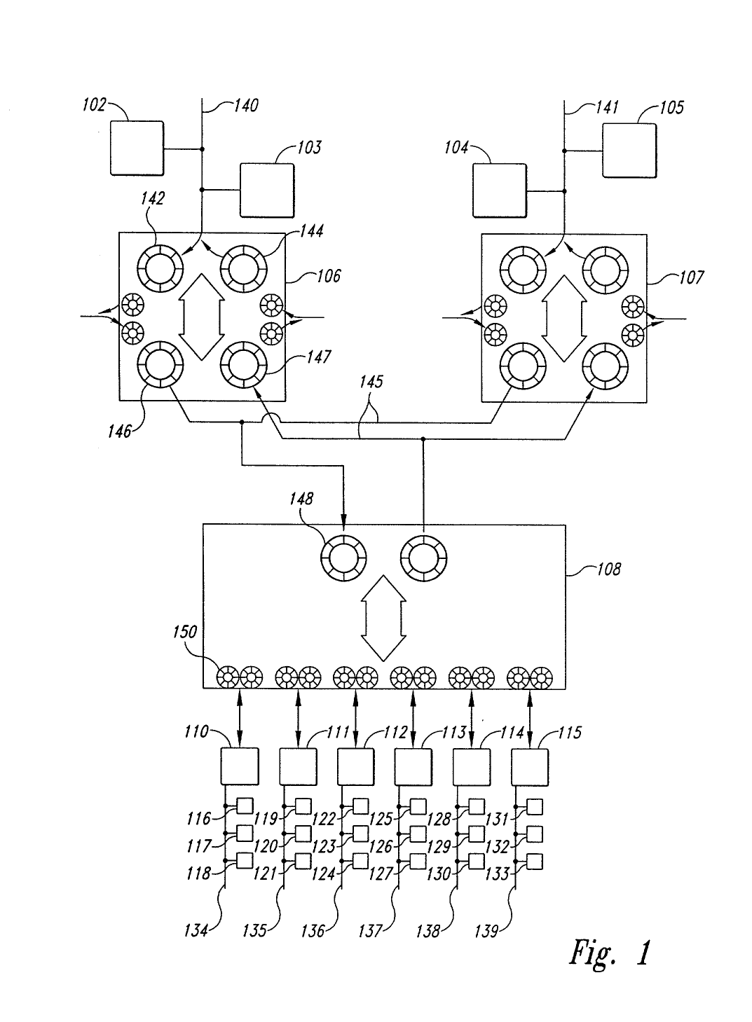

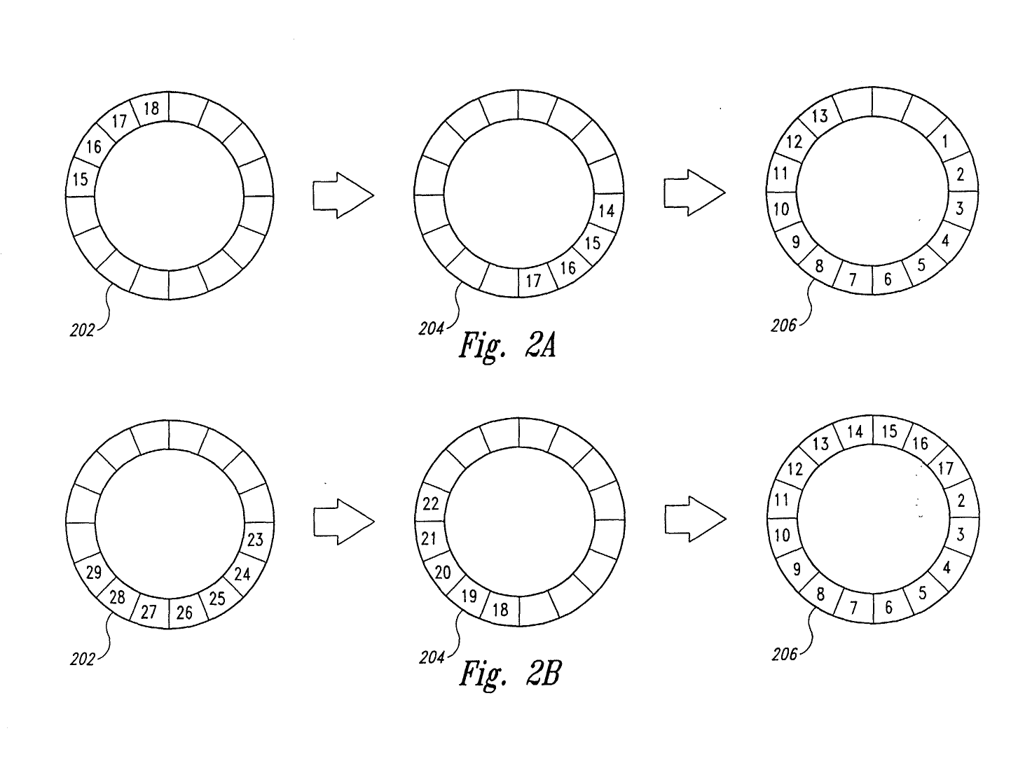

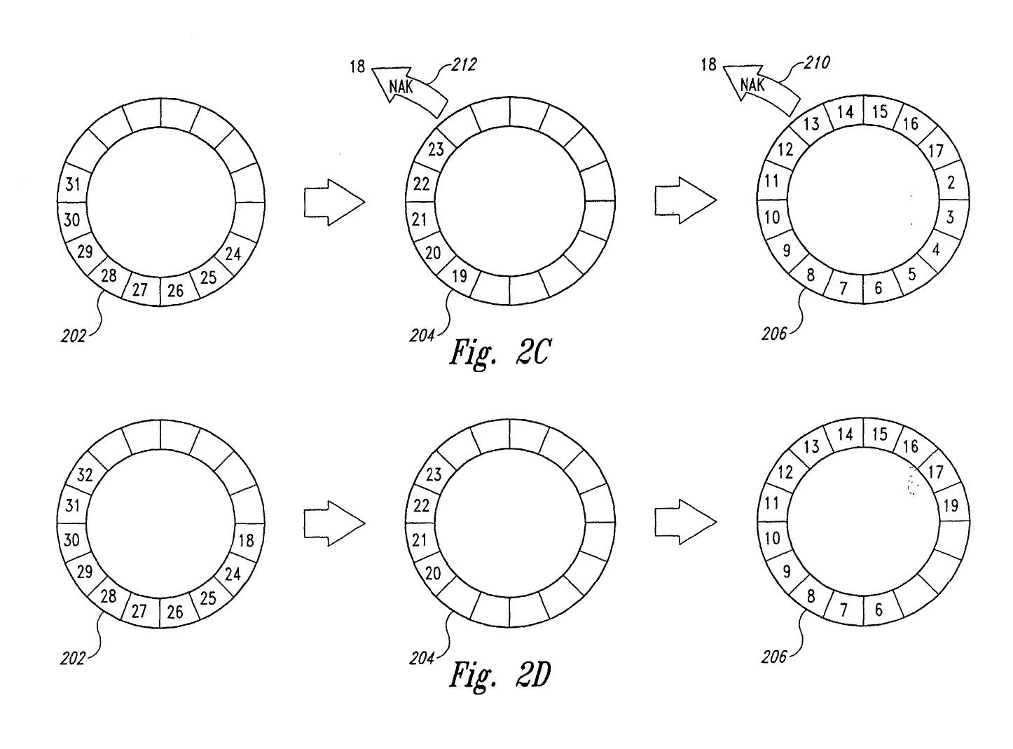

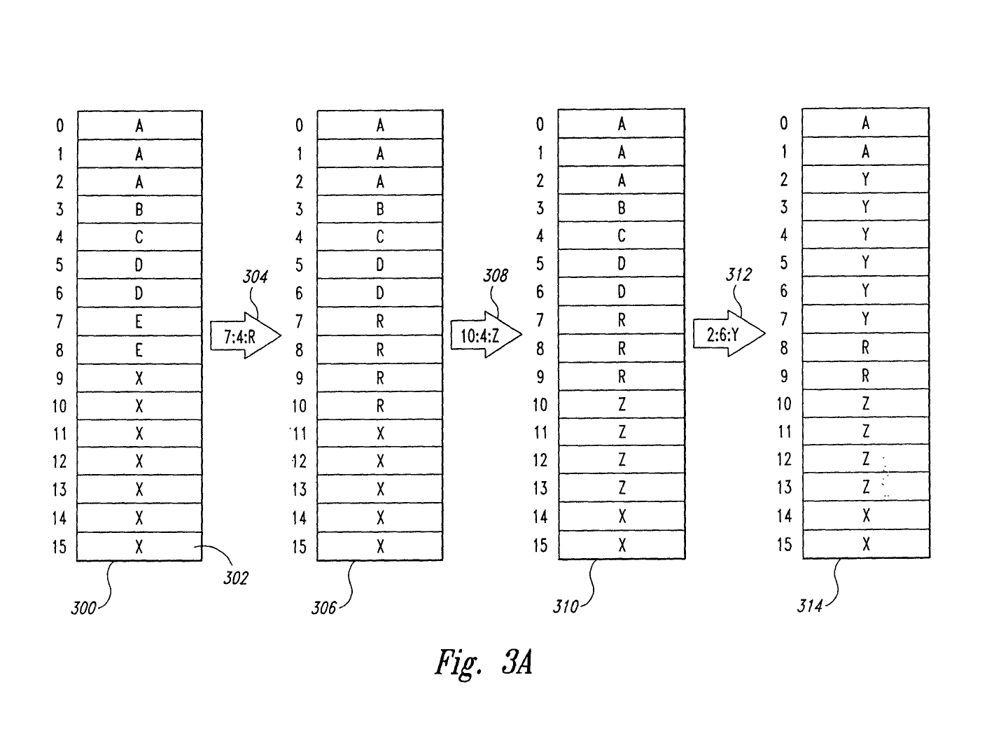

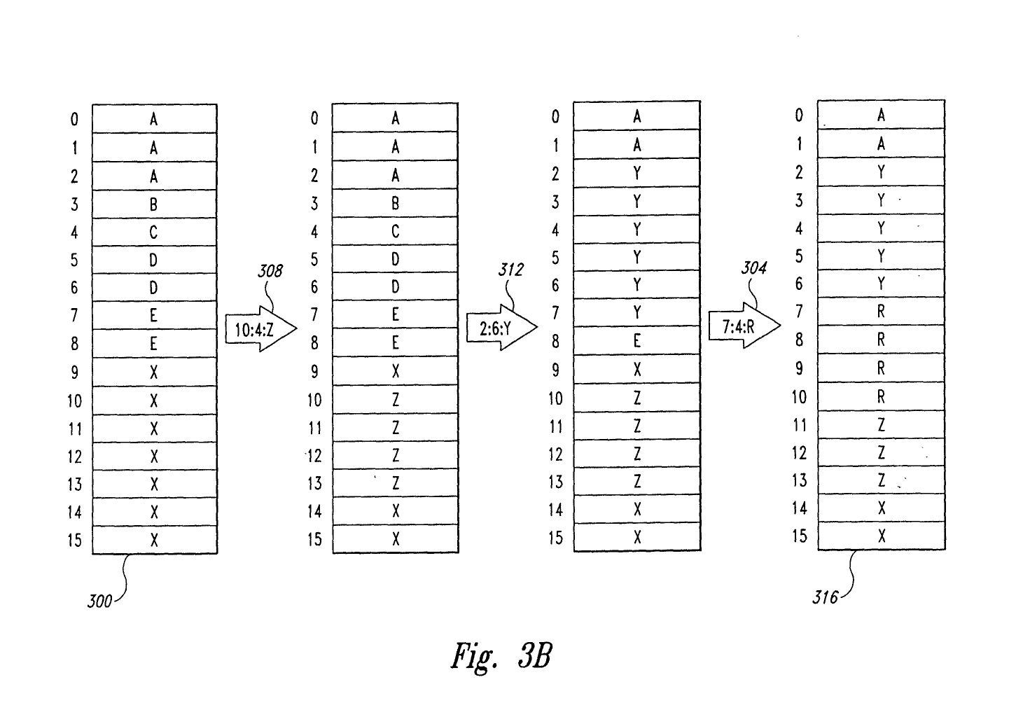

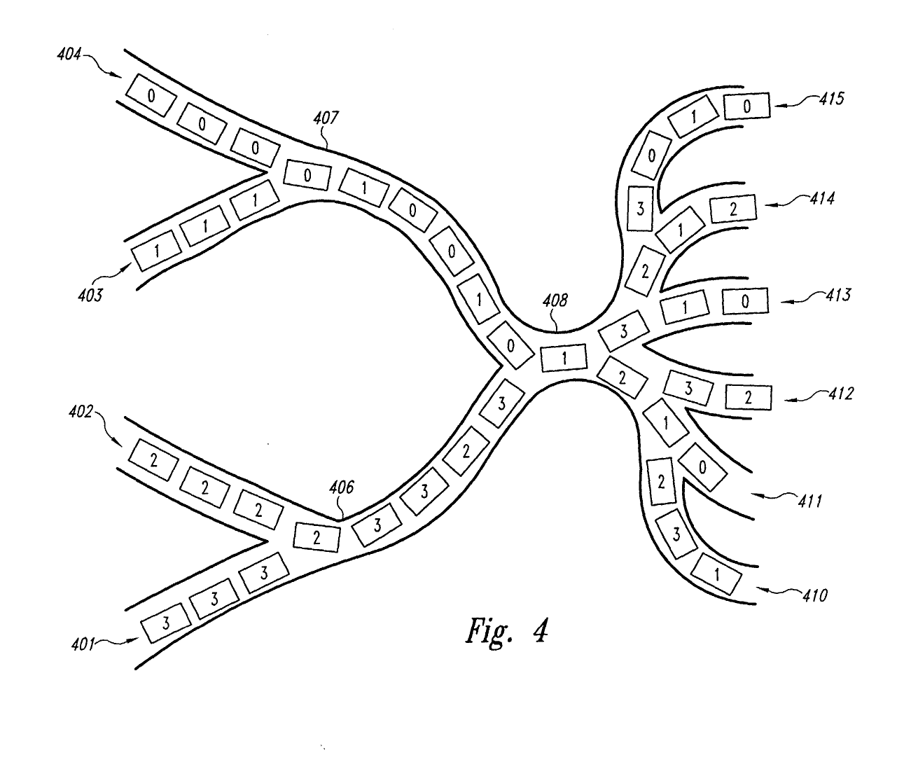

The present invention is related to a flow control technique that can be applied between a source node or producing node and a destination node or consuming node within a system of interconnected and intercommunicating electronic entities. As will be discussed below, the technique of the present invention can be applied in many different ways within a system of interconnected and intercommunicating electronic entities. In the following discussion, a simple application based on the computer system illustrated in FIG. 1 and referenced above will be discussed. In this discussion, a producing node, such as a north-bridge device (106-107 in FIG. 1), forwards I/O transaction requests to a consuming node, such as an I/O bridge (108 in FIG. 1), for forwarding on to a destination node, such as a south-bridge device (110 in FIG. 1).

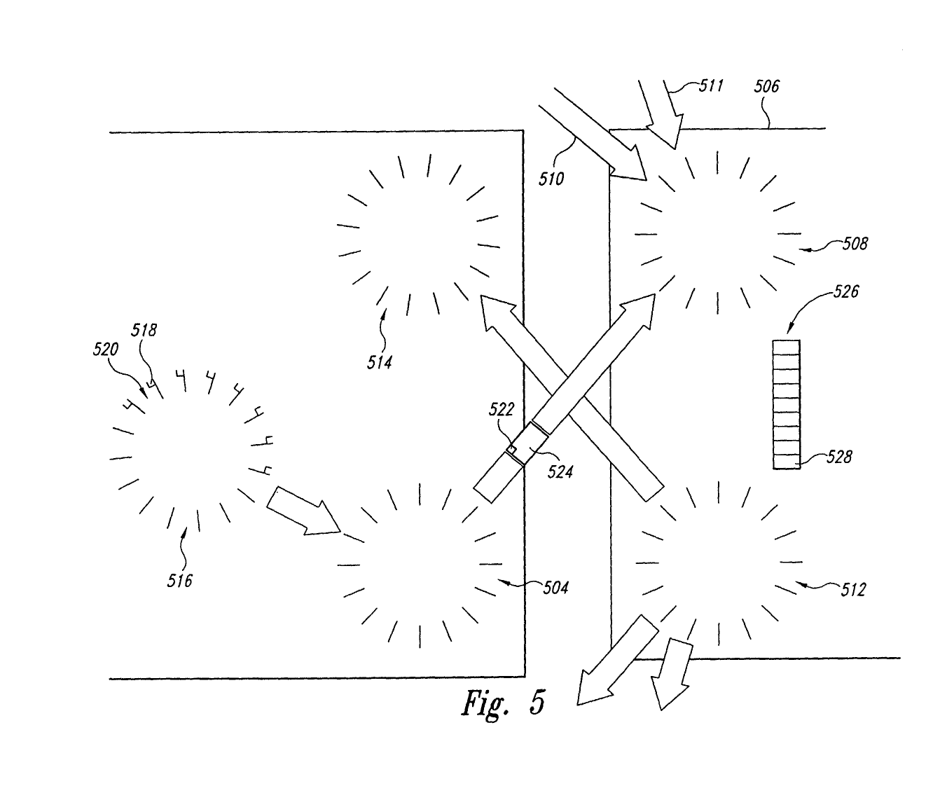

FIG. 5 shows the data structures employed by the producing and consuming nodes to which the flow control technique of the present invention is applied. In FIG. 5, a producing node 502 sends ordered transaction requests from a destination output queue 504 to a consuming node 506 containing a source input queue 508 into which received transaction requests from the producing node 502 and other producing nodes 510-511 are queued. The consuming node 506 additionally contains a source output queue 512 into which reply messages are queued for transmission back to producing nodes, including producing node 502. The reply messages received by producing node 502 are queued initially into a destination input queue 514 from which the messages are dequeued and queued to a source output queue (not shown in FIG. 5). Note that all input and output queues are first-in, first-out (“FIFO”) queues.

The transaction requests are initially received by the producing node 502 from an upstream source node and queued to source input queue 516. The producing node 502 stores outstanding transaction requests in the source input queue 516 until the producing node 502 receives an ACK reply from the consuming node via destination input queue 514. The source input queue 516 includes a retry bit, such as retry bit 518 corresponding to queued transaction request 520, for each queued transaction request. When the producing node 502 sends a transaction request to the consuming node, the producing node may include, or set, a special market bit, such as special marker bit 522 in transaction request 524 being transmitted from the producing node 502 to the consuming node 506. Finally, the consuming node 506 includes a retry vector 526 with a retry bit, such as retry bit 528, corresponding to each producing node, such as producing node 502, from which the consuming node receives transaction requests via the source input queue 508. Thus, the technique of one embodiment of the present invention relies on retry bits associated with queued transaction requests, special marker bits within transmitted transaction requests, and a retry vector stored within consuming nodes.

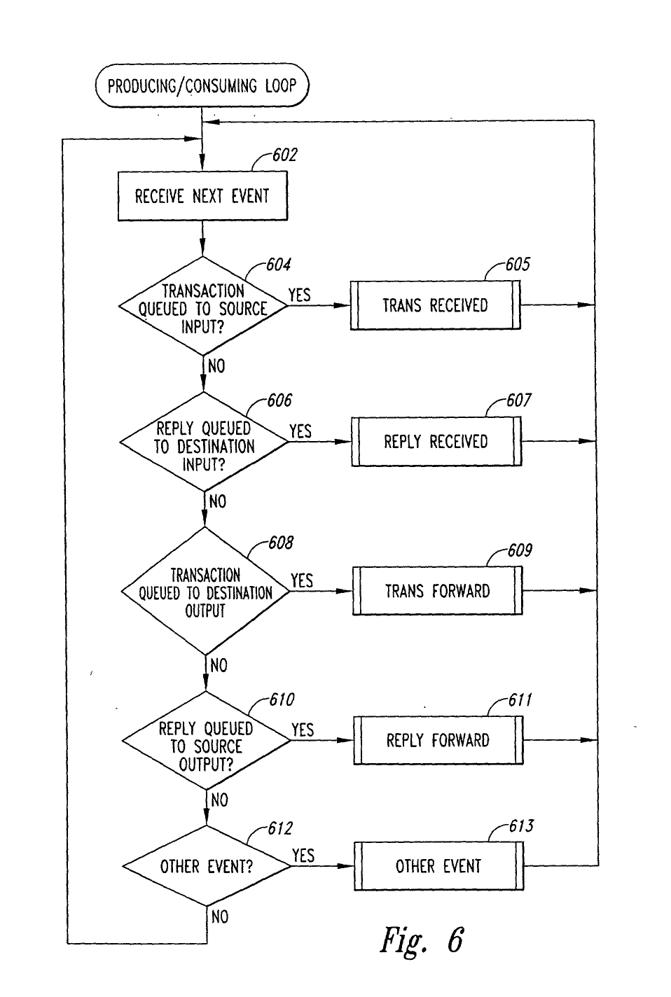

FIG. 5 provides an abstract model for a producing node and a consuming node that employ the technique of the present invention. This abstract model will be used as the basis for description of the flow-control technique of the present invention provided below with reference to FIGS. 6-9. Although the producing node in the present example is an intermediate node, the technique of the present invention may be employed to control flow of packets or messages between source nodes and ultimate destination nodes or between any combination of two nodes within an electronic communications pathway from a source node to a destination node, including two nodes separated in a path by one or more intermediate nodes.

FIGS. 6-9 are flow control diagrams that illustrate operation of the producing and sending nodes of FIG. 5 related to the flow control method of one embodiment of the present invention. FIG. 6 is a flow control diagram of an inner control loop within the control logic of both the producing and consuming nodes. In the embodiment described in FIGS. 6-9, the control logic of the producing and consuming nodes is event driven. Upon receiving notification of the occurrence of an event, such as queuing of a transaction request to an input queue, the inner control loop is awakened to handle the event and other events that may occur concurrently with handling of the first event. In step 602, the inner control loop waits to receive the next event. Upon reception of the event, the inner control loop proceeds to determine which event or events have occurred, in conditional steps 604, 606, 608, 610, and 612, and call event handlers to handle any detected event occurrences in steps 605, 607, 609, 611, and 613.

If a transaction request has been queued to a source input queue, as detected in step 604, then the inner control loop calls the procedure “trans_received,” in step 605, to handle transaction requests queued to the source input queue. If a reply message has been queued to a destination input queue, as detected in step 606, then the routine “reply_received” is called in step 607 to handle reply messages queued to the destination input queue. If a transaction request has been queued to a destination output queue, as detected in step 608, then the routine “trans_forward” is called, in step 609, to dequeue the queued transaction request and transmit the dequeued transaction request to a target node. If a reply message has been queued to a source output queue, as detected in step 610, then the routine “reply_forward” is called, in step 611, to dequeue the queued reply message and transmit the dequeued reply message to a target node. The routines “trans_forward” and “reply_forward” are not further described, as they involve straightforward, hardware-implemented communications medium interface logic. In general, the logic represented by these two routines may operate asynchronously with respect to logic corresponding to the routines “trans_received” and “reply_received” in FIG. 6, dequeuing transaction requests and reply messages from output queues, in first-in, first-out order, for transmission to remote nodes. Thus, rather than calling the routines “trans forward” and “reply forward” in steps 609 and 611, the inner control loop may toggle a register or otherwise notify the asynchronous logic components to examine the queues from which transaction requests and reply messages are dequeued for transmission to communications media. Addition lower-level logic queues incoming transaction requests and reply messages to input queues. In other implementations, the logic corresponding to the routines “trans_forward” and “reply_forward,” in FIG. 6, may continuously poll the output queues to detect new messages and requests for transmission. Finally, in FIG. 6, any other types of events handled by the inner control loops of the producing and consuming entities may be detected in step 612 and handled accordingly, in step 613, by a general event handling routine.

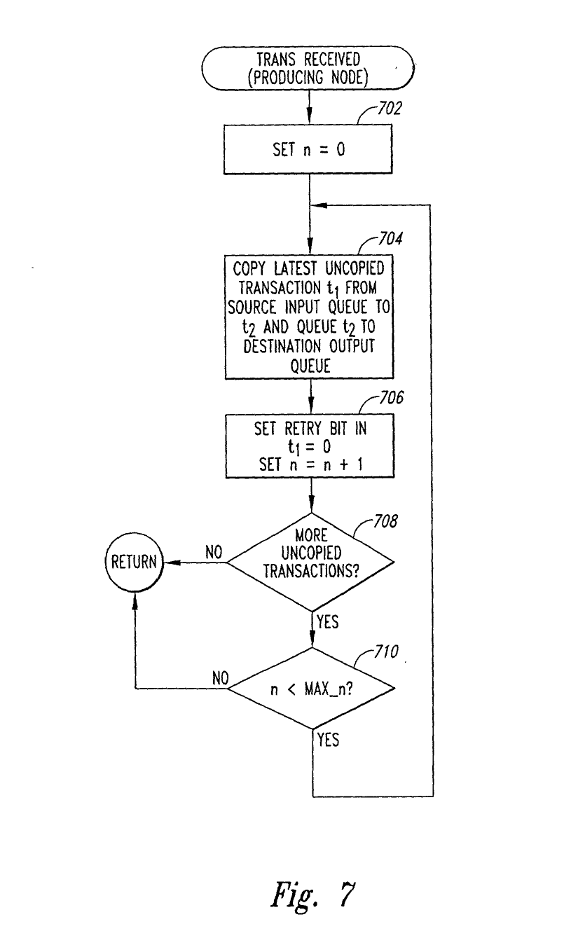

FIG. 7 is a flow control diagram for the routine “trans_received,” called by the inner control loop of a producing node. This routine processes recently received transaction requests from a source node queued by low-level logic to the source input queue. In step 702, the routine “trans_received” sets local variable n to zero. Local variable n is used to limit processing of received transaction requests in order that event handling for other types of events is not starved. In step 704, the routine “trans_received” finds the latest unprocessed transaction t₁ within the source input queue, copies transaction request t₁ into transaction request t₂, and queues transaction request t₂ to the destination output queue for transmission to the consuming node. In step 706, the routine “trans_received” sets the retry bit in transaction request t₁ to zero. Note that each received transaction request is stored within the source input queue until an ACK reply is received from the consuming node, allowing the transaction request stored in the source input queue to be deleted and, in certain implementations, the ACK reply to be passed back to the source node. Finally, in step 706, local variable n is incremented. In step 708, the routine “trans_received” determines whether or not there are more unprocessed transaction requests queued to the source input queue. If not, the routine “trans_received” returns. If there are more transaction requests queued to the source input queue, then, in step 710, the routine “trans_received” determines whether or not the value stored in local variable n is less than the maximum number of transaction requests max_n that should be processed at one time. If the routine “trans_received” determines that additional transaction requests can be processed, control flows back to step 704. Otherwise, the routine “trans_received” terminates.

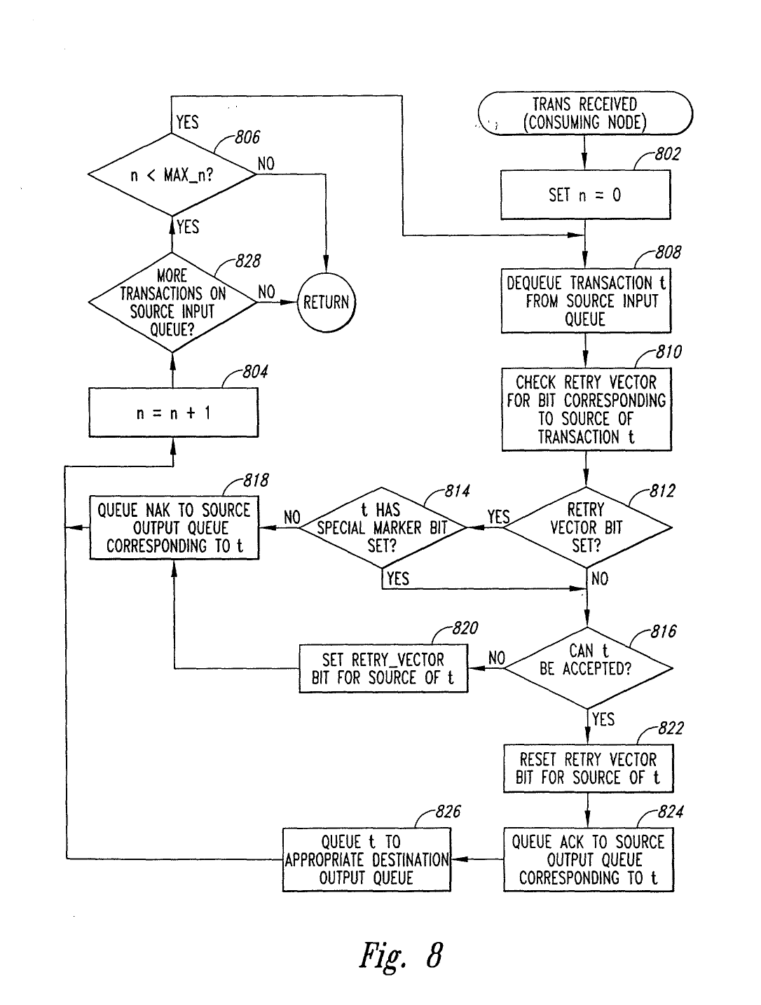

FIG. 8 is a flow control diagram for the routine “trans_received,” called from the inner control loop of the consuming node. This routine is called when the inner control loop of the consuming node determines that a transaction request has been received by the consuming node and queued to the source input queue of the consuming node. As in the routine “trans_received” for the producing node, discussed with reference to FIG. 7 above, the local variable n is initialized to zero in step 802 and is incremented in step 804 after processing a received transaction request. An additional transaction request, if one is present, may be processed by the routine “trans_received” only if the current value of the local variable n is less than some maximum number of transaction requests max_n that can be processed in a single call to the routine “trans_received,” as determined in step 806. In step 808, the routine “trans_received” dequeues the next unprocessed transaction request t from the source input queue. In step 810, the routine “trans_received” accesses the retry vector to determine the value of the bit corresponding to the source from which transaction request t has been received. If the retry vector bit corresponding to the source of transaction request t is set, as determined in step 812, then, in step 814, the routine “trans_received” determines whether a special market bit was set in the communications packet containing transaction request t. If the special marker bit was set, then transaction request t has been reissued by the producing node following rejection of the transaction request by the consuming node at a previous point in time. Moreover, transaction request t is the oldest, longest pending transaction request from the producing node directed to the consuming node following rejection by the consuming node of a recent transaction request. Thus, if the retry vector bit is not set, or the special marker bit in reissued transaction request t is set, then the consuming node proceeds to process the transaction request in step 816. Otherwise, in step 818, the consuming node queues a NAK reply corresponding to transaction request t and queues the NAK reply to the source output queue to complete processing of transaction request t.

In the first step of processing transaction request t, the routine “trans_received” determines, in step 816, whether there is sufficient room on the destination output queue corresponding to the destination to which transaction request t is directed for queuing transaction request t for transmission to the destination. If there is no room on the destination output queue, then the routine “trans_received” sets the retry vector bit corresponding to the source node for transaction request t to the consuming node in step 820, and proceeds, in step 818, to queue a NAK reply to the source to indicate that the transaction request t cannot be accepted for processing by the consuming node. Otherwise, if there is space on the destination output queue for transaction request t, then, in step 822, the routine “trans_received” resets the retry vector bit corresponding to the source of transaction request t, queues an ACK reply corresponding to transaction request t to the source output queue corresponding to the source of transaction request t in step 824, and queues transaction request t to the destination output queue corresponding to the destination to which transaction request t is directed in step 826. After incrementing local variable n in step 804, the routine “trans_received” determines, in step 828, whether or not there are more unprocessed transaction requests on the source input queue. If there are no more transaction requests to process, then the routine “trans_received” returns. If another transaction request is queued to the source input queue, and if another transaction request can be processed in the current invocation of the routine “trans_received,” as determined in step 806, then control flows back to step 808.

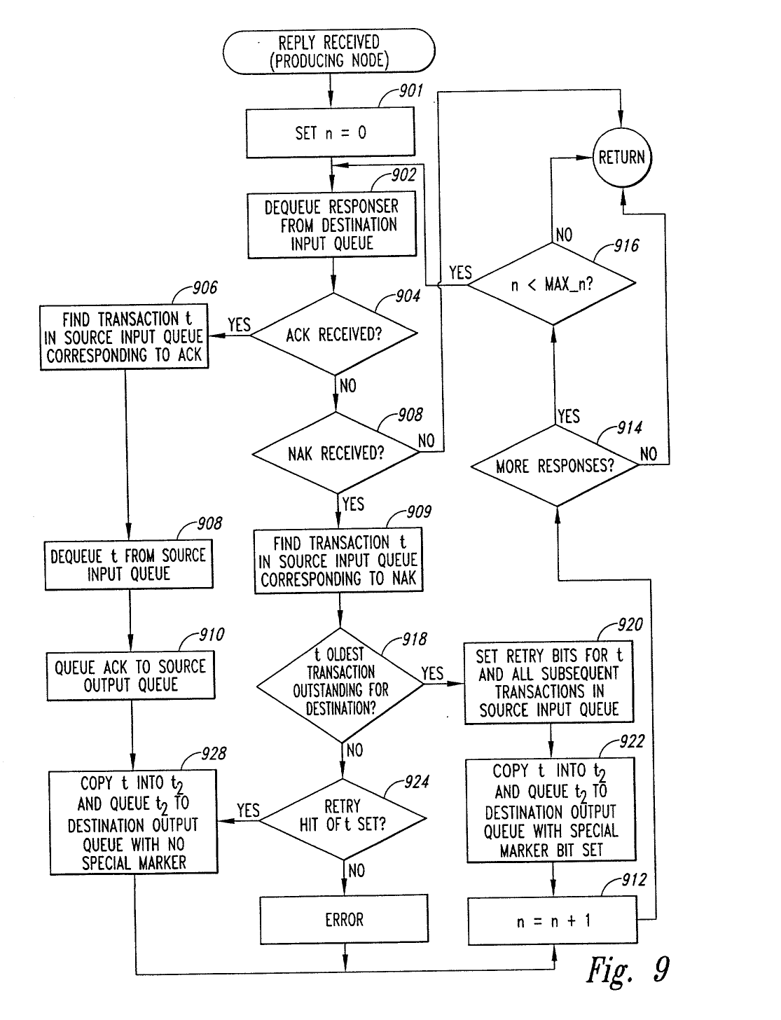

FIG. 9 is a flow control diagram for the routine “reply_received,” called by the inner control loop of a producing node upon queuing of a reply message to the destination input queue within the producing node. In step 901, the routine reply_received“sets the local variable n to zero in order to ensure that only a certain number of reply messages are processed in the current invocation of the routine “reply_received.” Also in step 902, the routine “reply_received” dequeues the least recently queued reply message r from the destination input queue for processing. In step 904, the routine “reply_received” determines whether the dequeued reply message r is an ACK reply. If so, then control flows to step 906. If not, then control flows to step 908, where the routine “reply_received” determines whether the dequeued reply message r is a NAK reply. If so, then control flows to step 910 and, otherwise, the routine “reply_received” returns.

The first step for processing a dequeued ACK reply message by the routine “reply_received” is to find the transaction request t stored in the source input queue corresponding to the received ACK reply. Next, in step 908, the stored transaction request t is dequeued from the source input queue. The dequeued transaction request has now been completed, at least with respect to the producing and consuming nodes. In step 910, the routine “reply_received” may queue an ACK reply to the source output queue to propagate the ACK reply back to the source from which the transaction request t was received. Step 910 is optional, depending on the protocol that controls information exchange between the source node and the producing node. Control then flows to step 912, where the local variable n is incremented, and then to step 914, in which the routine “reply_received” determines whether or not any additional unprocessed reply messages are queued to the destination input queue. If so, and if another reply message can be processed in the current invocation of the routine “reply_received,” as determined in step 916, then control flows to step 902. Otherwise, the routine “reply_received” returns.

Processing of NAK reply messages begins in step 910. In step 910, the routine “reply_received” finds the transaction request t in the source input queue corresponding to the received NAK reply. In step 918, the routine “reply_received” determines whether transaction class t is the oldest, or least recently received, transaction request outstanding for the consuming node to which transaction request t is directed. If so, then, in step 920, the retry bit for transaction request t is set within the source input queue, and the retry bits for all subsequent, or more recently received, transaction requests directed to the consuming node to which transaction request t is directed are also set in the source input queue. By setting the retry bits of all subsequent transaction requests directed to the consuming node to which transaction request t is directed, the routine “reply_received” ensures that retries of transaction request t and subsequent transaction requests will occur in the order in which the transaction requests were initially received by the producing node. In step 922, the routine “reply_received” copies transaction request t into transaction request t₂ and queues transaction request t₂ to the destination output queue corresponding to the consuming node to which transaction request t is directed. Note that, in this case, the routine “reply_received” marks the transaction request t₂ by setting the special market bit, so that when transaction request t₂ is received by the consuming node, the consuming node can determine that this is the first in a series of retried transaction requests. This complete processing of a NAK reply corresponding to the oldest transaction request outstanding for a particular consuming node.

If the received NAK reply message r does not correspond to the oldest outstanding transaction request for the consuming node from which the NAK reply message was received, as detected in step 918, then the routine “reply_received” determines, in step 924, whether the retry bit of the corresponding transaction request t stored in the source input queue has been set. If not, then a fundamental protocol error has occurred and error handling procedures are invoked in step 926. If the retry bit has been set, then transaction request t is copied into transaction request t₂ and transaction request t₂ is queued to the destination output queue corresponding to the destination to which transaction request t is directed, in step 928, with no special market set. This completes processing of the NAK reply message. After either step 922 or step 928, the routine “reply_received” increments the local variable n in step 912 and continues to process additional reply messages, if possible, or returns.

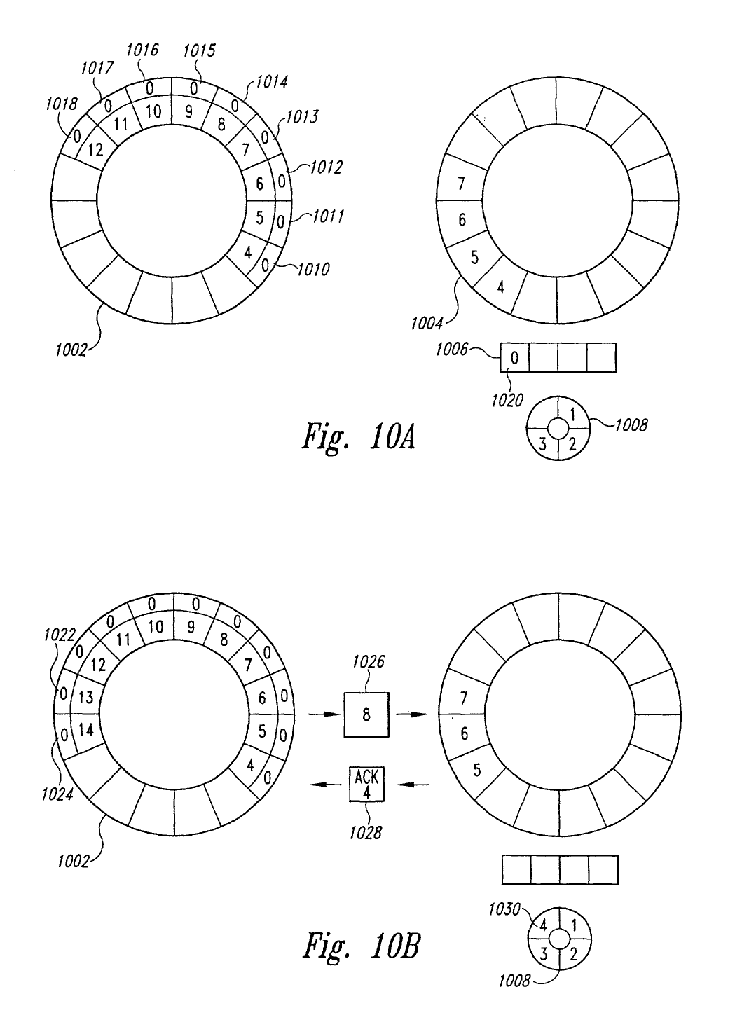

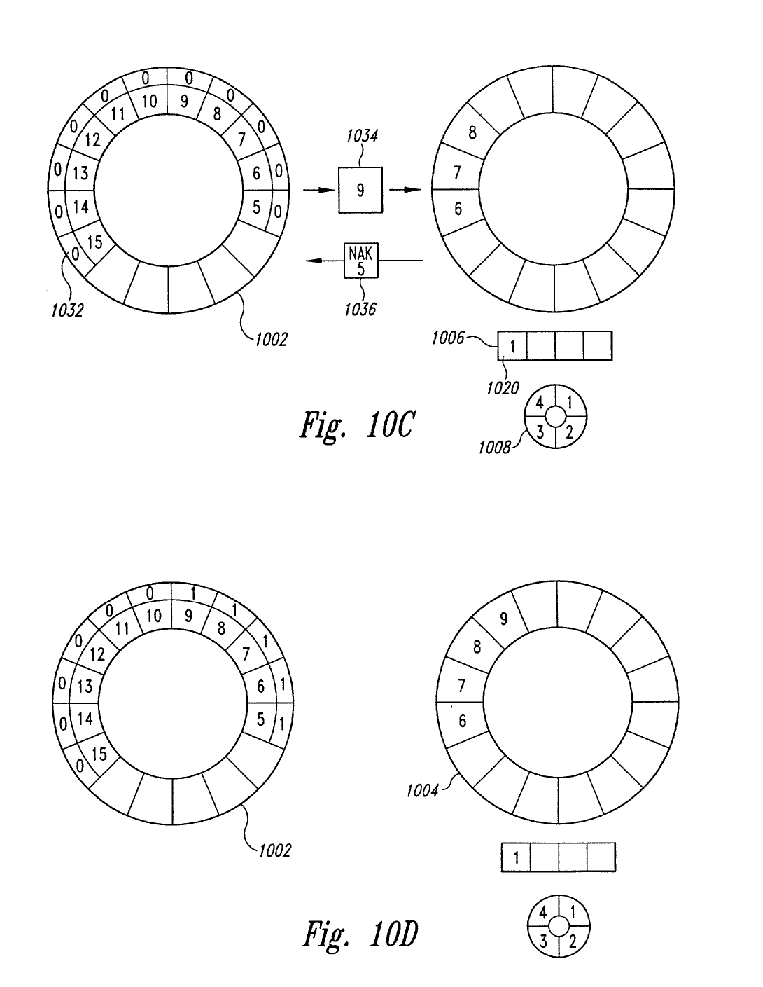

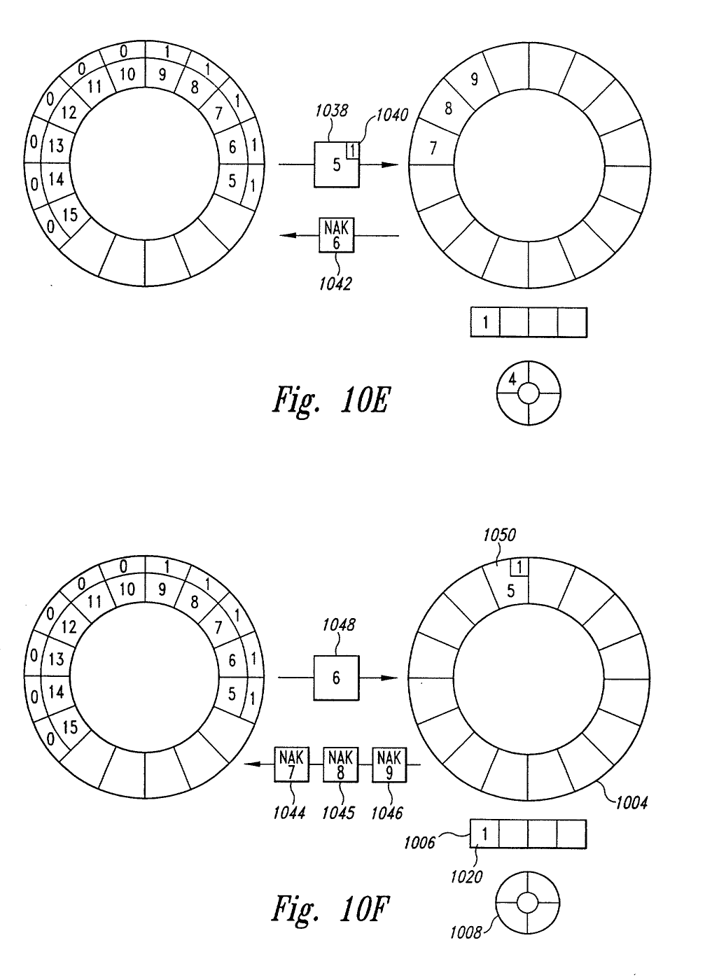

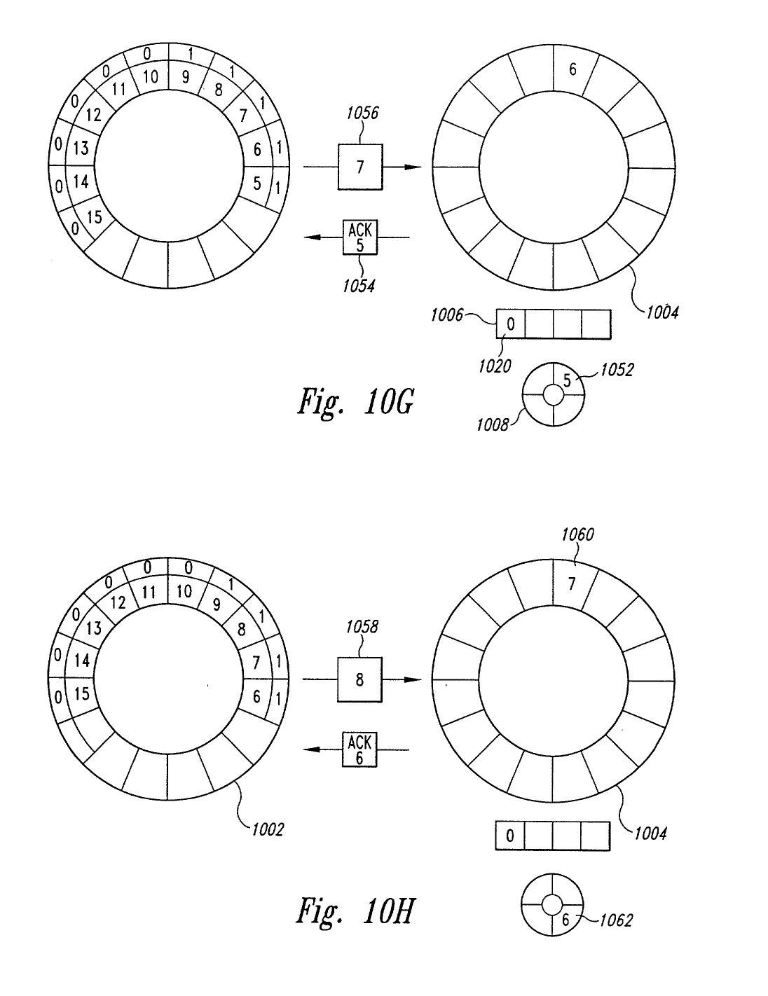

FIGS. 10A-H illustrate operation of the flow control technique of one embodiment of the present invention as applied to the producing and consuming nodes illustrated in FIG. 5. FIGS. 10A-H employ a simplified, abstract illustrative convention. The source input queue 1002 for the producing node is shown on the left side of each of FIGS. 10A-H. The source input queue for the consuming node 1004, retry vector 1006, and destination output queue for a particular destination 1008 are all shown on the right-hand side of FIGS. 10A-H. In the example illustrated in FIGS. 10A-H, an ordered sequence of fifteen transaction requests is being forwarded form the producing node to the consuming node. The ordered sequence of transaction requests are presumed to be received by the producing node form an upstream source, and are directed to a destination node corresponding to the destination output queue 1008 maintained by the consuming node. As discussed above with reference to FIG. 1, the producing and consuming nodes may concurrently handle many different sources and destinations for transaction requests and reply messages. However, in order to simplify the following discussion and clearly illustrate operation of the flow control protocol that represents one embodiment of the present invention, the processing of only a portion of a single sequence of ordered transaction requests originating at one source and directed to a single destination is illustrated. The flow control technique can be concurrently applied by any particular pair of producing and consuming nodes, source and destination nodes, producing and destination nodes, or source and consuming nodes, and can be concurrently applied to independent streams of transaction requests and reply messages received from, and directed to, a variety of different nodes, as well as to different flow control classes into which independent streams of transaction requests and reply messages may be partitioned.

In FIG. 10A, the source input queue 1002 for the producing node contains transaction requests 4-12 (1010-1018 in FIG. 10A, respectively). Transaction requests 1-3 of the ordered series of transaction requests have already been transmitted from the producing node to the consuming node and accepted by the consuming node, which has placed transaction requests 1-3 onto the destination output queue 1008 for transmission to the destination to which they are intended. The bit of the retry vector 1020 corresponding to the producing node containing the source input queue 1002 has the value “0,” indicating that no transaction requests have been recently refused by the consuming node. Note also that the retry bits within transaction requests 4-12 (1010-1018 in FIG. 10A, respectively) are currently set to 0, indicating that the transaction requests are not currently marked for retransmission.

In FIG. 10B, two additional transaction requests 1022 and 1024 have been queued to the source input queue 1002 of the producing node. The producing node is transmitting transaction request 8 (1026 in FIG. 10B) to the consuming node, and the consuming node is transmitting the ACK reply message 1028 corresponding to transaction request 4 back to the producing node. Note also that the fourth transaction request 1030 is now queued to the destination output queue 1008. At this point in time, the destination output queue is full, and the destination, either because of an error condition or a temporarily slow transaction request processing rate, is not currently processing transaction requests at a sufficient rate to allow additional transaction requests to be queued to the destination output queue 1008 by the consuming node.

In FIG. 10C, the final transaction request 1032 in the series of transaction requests has been queued to the source input queue 1002 of the producing node. The producing node is in the process of transmitting transaction request 9 1034 to the consuming node, and the consuming node is sending a NAK reply message 1036 back to the producing node to indicate that the consuming node cannot accept another transaction request directed to the destination corresponding to destination output queue 1008. Note that the bit 1020 in the retry vector 1006 corresponding to the producing node has now been set, indicating that the consuming node has recently rejected a transaction request from the producing node.

In FIG. 10D, the producing node has received the NAK reply for transaction request 5 (1036 in FIG. 10C) from the consuming node and has processed the NAK reply for transaction request 5 according to the technique illustrated in FIG. 9. Namely, the producing node has set the retry bits for all pending transaction requests (transaction requests 5-9) directed to the consuming node within the source input queue 1002. Transaction requests 10-15 are not pending, since they have not yet been transmitted to the consuming node. Note that transaction request 9 (1034 in FIG. 10C) has been received by the consuming node and queued to the source input queue 1004 of the consuming node.

In FIG. 10E, the producing node retransmits transaction request 5 1038 to the consuming node with the special bit marker 1040 set to indicate to the consuming node that this is the first of a sequence of retransmitted transaction requests. Transaction request 5 is the longest pending transaction request. At the point in time illustrated in FIG. 10E, the consuming node is transmitting a NAK reply message 1042, corresponding to transaction request 6, back to the producing node.

In FIG. 10F, NAK reply messages for transaction requests 7, 8 and 9 1044-1046, respectively, are being sent by the consuming node back to the producing node as transaction requests 7-9 are dequeued from the source input queue 1004 of the consuming node, since the bit 1020 in the retry vector 1006 of the producing node is set. Note that the destination output queue 1008 of the consuming node is now empty, as the destination has resumed processing transaction requests. However, because of the bit 1020 in the retry vector 1006 being set, the consuming node rejects transaction requests 7, 8 and 9. In FIG. 10F, the producing node is retransmitting transaction request 6 1048 to consuming node, which is received and queued via transmission of transaction request 5 1050.

In FIG. 10G, the consuming node has dequeued the retransmitted transmission request 5 from the source input queue 1004 and, noting that the special bit marker is set in the retransmitted transaction request, has cleared the bit 1020 of the retry vector 1026 corresponding to the producing node and queued transaction request 5 (1052 in FIG. 10G) to the destination output queue 1008. The consuming node has transmitted an ACK reply message 1054 corresponding to transaction request 5 back to the producing node. The producing node is retransmitting transaction request 7 (1056 in FIG. G) to the consuming node.

Finally, FIG. 10H shows full resumption of processing of the ordered series of transaction requests by the producing and consuming nodes. The producing node has received the ACK reply message (1054 in FIG. 10G) corresponding to transaction request 5, and has dequeued transaction request 5 from the source input queue 1002. The producing node is retransmitting transaction request 8 (1058 in FIG. 10H) to the consuming node. The consuming node has queued the retransmitted transaction request 7 (1060 in FIG. 10H) to the source input queue 1004 and has queued transaction request 6 (1062 in FIG. 10H) to the destination output queue. Should the destination continue to process transaction requests in a timely fashion, the remaining retries of rejected transaction requests will successfully complete, and then the transaction requests 10-15 will be sent to the consuming node and acknowledged by the consuming node, completing processing of the transaction requests. Thus, the example illustrated in FIGS. 10A-H show how the retry bits, special bit marker, and retry vector are used by the producing and consuming nodes to ensure that rejected transaction requests are retried in order to prevent out-of-order consumption and processing of transaction requests by the consuming node.

Although the present invention has been described in terms of a particular embodiment, it is not intended that the invention be limited to this embodiment. Modifications within the spirit of the invention will be apparent to those skilled in the art. For example, the producing node and consuming node may be directly interconnected, as an example of FIG. 5, or may be indirectly interconnected through additional nodes. The flow control technique of the present invention may be applied in either situation. This flow control technique can be applied to both originating nodes, such as processors of FIG. 1, or to intermediary nodes that coalesce and distribute independent packet streams, forwarding incoming packets and other types of communication messages to downstream destinations. In general computer system implementations, communications packets and messages transmitted under a single communications medium may be partitioned into flow control groups, with flow control techniques applied separately, but concurrently, to each flow control partition, or class. The techniques of the present invention may also be applied concurrently to different flow control classes, a separate retry vector associated with each flow control class. In the embodiment discussed with reference to FIG. 5, the retry vector included a bit for each producing node. It is also possible to provide a bit for each distinct producing node/source node pair, if the producing node is receiving the packets of messages from the source node, or distinct node triples in the case that three upstream nodes originate and forward messages to a particular consuming node. Thus, the granularity of application of the flow control technique of the present invention may be selected based on implementation overhead, availability of memory and processing capacity, and other such factors. The flow control technique encompasses many different variations. For example, rather than NAK all subsequent transaction requests after NAK-ing an initial transaction request, a consuming node may only NAK the first transaction request, and the producing node may likewise expect only a single NAK for an entire subsequence of transaction requests. Many other variations in the protocol are possible. It should be noted that, in the examples discussed, that message sequencing is assumed to be handled at some level below the control logic described in the flow control diagrams of FIGS. 6-10. The technique of the present invention may also be applicable in situations where message ordering is not handled at lower control logic levels. As with any logic implementation, the technique of the present invention may be implemented in hardware circuits, as firmware programs, and may even be implemented in a software program, as well as combinations of two or more of these implementation techniques. In all cases, there are an almost limitless number of different physical implementations that provide the functionality of the flow control technique discussed above with reference to FIGS. 5-10.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for controlling flow of requests and replies between a first electronic device that stores new and pending requests in an electronic memory and retrieves new and pending requests from the electronic memory for transmission, and a second electronic device that accepts requests transmitted from the first electronic device, transmitting back to the first electronic device an ACK reply, and rejects requests transmitted from the first electronic device, transmitting back to the first electronic device a NAK reply, the method comprising:
storing by the first electronic device a retry bit associated with each stored request;
storing by the second electronic device a retry vector containing bits corresponding to electronic devices from which the second electronic device receives requests;
maintaining a copy in storage, by the first electronic device, of each request until an ACK reply corresponding to the request is received by the second electronic device;
employing the retry bits associated with each stored request by the first electronic device to mark requests for retransmission; and
employing the retry vector by the second electronic device to mark electronic devices that need to retransmit one or more rejected requests.

2. The method of claim 1 wherein, when the first electronic device receives a NAK reply from the second electronic device:
when the request corresponding to the NAK reply is the oldest pending request directed to the second electronic device, setting the retry bits of all subsequent requests directed to the second electronic device and retransmitting the oldest pending request to the second electronic device with a special marker bit; and
when the request corresponding to the NAK reply is not the oldest pending request directed to the second electronic device, retransmitting the request to the second electronic device without a special marker bit.

3. The method of claim 1 wherein, when the second electronic device receives a request from the first electronic device:
when the retry vector bit corresponding to the first electronic device is set and when no special marker bit is set in the request, sending a NAK reply back to the first electronic device; and
when the retry vector bit corresponding to the first electronic device is not set or a special marker bit is set in the request,
determining if the request can be processed by the second electronic device,
when the request can be processed by the second electronic device, resetting the retry vector bit corresponding to the first electronic device and sending an ACK reply back to the first electronic device, and
when the request cannot be processed by the second electronic device, setting the retry vector bit corresponding to the first electronic device and sending a NAK reply back to the first electronic device.

4. The method of claim 1 wherein the first electronic device stores new and pending requests in a source input queue.

5. The method of claim 1 wherein the first electronic device is a source node and the second electronic device is a destination node within a computer system comprising interconnected and intercommunicating electronic devices.

6. The method of claim 1 wherein the first electronic device is a producing node and the second electronic device is a destination node within a computer system comprising interconnected and intercommunicating electronic devices.

7. The method of claim 1 wherein the first electronic device is a producing node and the second electronic device is a consuming node within a computer system comprising interconnected and intercommunicating electronic devices.

8. The method of claim 1 wherein the first electronic device is a source node and the second electronic device is a consuming node within a computer system comprising interconnected and intercommunicating electronic devices.

9. The method of claim 1 wherein the first electronic device is directly connected to the second electronic device by an electronic communications medium.

10. The method of claim 1 wherein the first electronic device is indirectly connected to the second electronic device by a first electronic communications medium, a forwarding node, and a second electronic communications medium.

11. The method of claim 1 wherein the first electronic device is indirectly connected to the second electronic device by a number of electronic communications media and forwarding nodes.

12. The method of claim 1 wherein the first electronic device and second electronic device are bus interconnect components within a computer system.

13. The method of claim 1 wherein each bit of the retry vector corresponds to an electronic device, directly connected to the second electronic device, that can send requests to the second electronic device.

14. The method of claim 1 wherein each bit of the retry vector corresponds to a unique set of electronic devices that originate and forward requests to the second electronic device.

15. A system containing two intercommunicating electronic devices comprising:
a first electronic device that stores new and pending requests in an electronic memory and retrieves new and pending requests from the electronic memory for transmission;
a retry bit associated with each stored request within the first electronic device;
a second electronic device that accepts requests transmitted from the first electronic device, transmitting back to the first electronic device an ACK reply, and rejects requests transmitted from the first electronic device, transmitting back to the first electronic device a NAK reply; and
a retry vector maintained by the second electronic device containing bits corresponding to electronic devices from which the second electronic device receives requests that need to retransmit one or more rejected requests.

16. The system of claim 15 further comprising:
control logic within the first electronic device that, when a request corresponding to a NAK reply is the oldest pending request directed to the second electronic device, sets the retry bits of all subsequent requests directed to the second electronic device and retransmits the oldest pending request to the second electronic device with a special marker bit.

17. The system of claim 16 wherein, when a request corresponding to the NAK reply is not the oldest pending request directed to the second electronic device, the control logic retransmits the request to the second electronic device without a special marker bit.

18. The system of claim 15 further comprising:
control logic within the second electronic device that receives a request from the first electronic device and, when the retry vector bit corresponding to the first electronic device is set and when no special marker bit is set in the request, sends a NAK reply back to the first electronic device.

19. The system of claim 18 wherein, when the retry vector bit corresponding to the first electronic device is not set or a special marker bit is set in a received request, the control logic determines if the request can be processed by the second electronic device and, when the request can be processed by the second electronic device, resets the retry vector bit corresponding to the first electronic device and sends an ACK reply back to the first electronic device.

20. The system of claim 19 wherein, when the request cannot be processed by the second electronic device, the control logic sets the retry vector bit corresponding to the first electronic device and sends a NAK reply back to the first electronic device.
